(19) United States
(12) Patent Application Publication
(10) Pub. No.: US 2015/0050954 A1
(43) Pub. Date: Feb. 19, 2015

(54) TERMINAL DEVICE, MOBILE MANAGEMENT DEVICE, COMMUNICATION SYSTEM, AND COMMUNICATION METHOD

(71) Applicant: Sharp Kabushiki Kaisha, Osaka-shi, Osaka (JP)

(72) Inventors: Toshiaki Kameno, Osaka-shi (JP); Hidenobu Fukumasa, Osaka-shi (JP); Shusaku Fukumoto, Osaka-shi (JP); Shuichi Takehana, Osaka-shi (JP); Yuichi Nobusawa, Osaka-shi (JP)

(21) Appl. No.: 14/386,897

(22) PCT Filed: Apr. 17, 2013
(86) PCT No.: PCT/JP2013/061393

§ 371 Date: Sep. 22, 2014

(30) Foreign Application Priority Data
Apr. 19, 2012 (JP) 2012-095796

(51) Int. Cl. H04W 48/18; H04W 4/00

(52) U.S. Cl. CPC H04W 48/18; H04W 4/006
USPC 455/509

(57) ABSTRACT

An operation requesting unit of a terminal device configured to, in a case that the terminal device is unable to be connected to a gateway device configured to connect a public wireless communication network and a short-range wireless communication network, transmit to the mobile management device, a gateway operation request signal that requests operation while regarding the terminal device as a gateway device.

### TECHNICAL FIELD

The present invention relates to a terminal device, a mobile management device, a communication system, and a communication method.

Priority is claimed on Japanese Patent Application No. 2012-095796, filed Apr. 19, 2012, the content of which is incorporated herein by reference.

### BACKGROUND ART

Conventionally, systems for machine-type communication (MTC, which is also referred to as machine communication), which is performed autonomously between devices without user operation, have been developed. MTC is applied to, for example, services for providing to users, data measured by measuring devices, data collected by monitoring systems, information concerning a risk detected, and the like. In some cases, MTC terminal devices (also referred to as MTC devices) are used for collection and detection of data. In other words, MTC terminal devices are terminal devices to be used for MTC. In some cases, MTC terminal devices transmit the data detected and collected to an MTC server device via a terrestrial public mobile communication network (also referred to as a public land mobile network (PLMN)). The MTC server device aggregates the data received from the MTC terminal devices and provides those data to the users.

In some cases, a vast number of MTC terminal devices are used for MTC, though the amount of information transmitted and received by each MTC terminal device is relatively small. There have been some cases where each MTC terminal accesses an MTC server at the same time, and thus communication resources become temporarily insufficient, thereby causing disconnection of communication. To mitigate such a problem, for example, Non-Patent Documents 1 and 2 propose that an MTC short-range wireless network (MTC capillary network) is configured for each group including a plurality of MTC terminal devices. In this network, an MTC gateway device connectable to a terrestrial public mobile communication network aggregates data from other MTC terminal devices or short-range wireless terminal devices (also referred to as local access devices), and transmits the aggregated data to the MTC server. Unlike the MTC terminal devices, the short-range wireless terminal devices are terminal devices that do not have the capability to establish connection to the terrestrial public mobile communication network.

### CITATION LIST

### Non-Patent Document

[Non-Patent Document 1] 3GPP TS 22.368 Service Requirements for Machine-Type Communications (MTC) Stage 1, 3GPP Organizational Partners, 2011.9, V11.3.0
[Non-Patent Document 2] 3GPP TR 22.888 Study on Enhancements for MTC, 3GPP Organizational Partners, 2011.5, V0.5.0

### DISCLOSURE OF THE INVENTION

### Problems to be Solved by the Invention

However, in order to construct the short-range wireless network described in Non-Patent Documents 1 and 2, operations have been necessary, such that user operates the MTC terminal device and sets identification information, such as an address, of the MTC terminal device or the MTC gateway device. On the other hand, the MTC terminal devices are occasionally installed in places where work by hand is difficult to perform. Additionally, even if such work is performed, there have been problems, such that establishment of connection fails, or construction of a short-range wireless network is not easy.

The present invention has been made in view of the above situations, and provides a terminal device, a mobile management device, a communication system, and a communication method, for which a short-range wireless network for MTC can be easily constructed.

### Means for Solving the Problems

(1) The present invention has been made to solve the above problems. One aspect of the present invention is a terminal device including: an operation requesting unit configured to, in a case that the terminal device is unable to be connected to a gateway device configured to connect a public wireless communication network and a short-range wireless communication network, transmit to the mobile management device, a gateway operation request signal that requests operation while regarding the terminal device as a gateway device.
(2) Another aspect of the present invention is the above-described terminal device further including a data processing unit configured to, in a case that the terminal device is able to be connected to the gateway device configured to connect the public wireless communication network and the short-range wireless communication network, transmit or receive data concerning a predetermined service, via the gateway device.
(3) Another aspect of the present invention is the above-described terminal device further including a data transferring unit configured to transmit to a base station device, data received from another terminal device, or transmit to the other terminal device, data received from the base station device.
(4) Another aspect of the present invention is a mobile management device including: a gateway information storing unit configured to store base station device information and gateway information in association with the base station device information, the base station device identifying a base station device, and the gateway information concerning a gateway device connected to the base station device, the gateway device being configured to connect a public wireless communication network and a short-range wireless communication network; a gateway information providing unit configured to receive from a terminal device via a base station device, a gateway request signal that requests gateway information, and transmit to the terminal device, gateway information concerning the base station device relaying the gateway request signal; and a gateway information registering unit configured to, in a case that an operation request signal that requests operation while regarding the terminal device as the gateway device is received from the terminal device via the base station device, have the gateway information storing unit store gateway information concerning the terminal device in association with the base station device information.
(5) Another aspect of the present invention is a communication system including: a gateway device configured to connect a public wireless communication network and a short-range wireless communication network; a terminal device; a base station device; a mobile management device configured to store base station information that identifies the base station device and gateway information concerning the gateway device. The terminal device includes an operation requesting unit configured to, in a case that the terminal device is unable to be connected to the gateway device, transmit to the mobile management device, an operation request signal that requests operation while regarding the terminal device as a gateway device.
(6) Another aspect of the present invention is a communication method for a terminal device. The communication method includes a step for the terminal device to, in a case that the terminal device is unable to be connected to the gateway device, transmit to the mobile management device, an operation request signal that requests operation while regarding the terminal device as a gateway device.
(7) Another aspect of the present invention is a communication method for a mobile management device including a gateway information storing unit configured to store base station device information and gateway information in association with the base station device information, the base station device identifying a base station device, and the gateway information concerning a gateway device connected to the base station device, the gateway device being configured to connect a public wireless communication network and a short-range wireless communication network. The communication method includes: a first step for the mobile management device to receive from a terminal device via a base station device, a gateway request signal that requests gateway information, and transmit to the terminal device, gateway information concerning the base station device relaying the gateway request signal; and a second step for the mobile management device to, in a case that an operation request signal that requests operation while regarding the terminal device as the gateway device is received from the terminal device via the base station device, have the gateway information storing unit store gateway information concerning the terminal device in association with the base station device information.

### Effects of the Invention

According to the description of the embodiments of the present invention, it is possible to easily construct a short-range wireless network for MTC.

### BRIEF DESCRIPTION OF THE DRAWINGS

FIG. 1 is a schematic diagram showing a communication system according to an embodiment of the present invention.

FIG. 2 is a schematic diagram showing a configuration of an MTC terminal device according to the present embodiment.

FIG. 3 is a schematic diagram showing a configuration of a short-range wireless terminal device according to the present embodiment.

FIG. 4 is a schematic diagram showing a configuration of an MTC gateway device according to the present embodiment.

FIG. 5 is a schematic diagram showing a configuration of an SGSN/MME according to the present embodiment.

FIG. 6 is a sequence diagram showing a communication process according to the present embodiment.

FIG. 7 is a flowchart showing a communication process to be performed by the MTC terminal device according to the present embodiment.

FIG. 8 is a schematic diagram showing another aspect of the communication system according to the present embodiment.

FIG. 9 is a schematic view showing still another aspect of the communication system according to the present embodiment.

FIG. 10 is a schematic view showing still yet another aspect of the communication system according to the present embodiment.

### BEST MODE FOR CARRYING OUT THE INVENTION

Hereinafter, an embodiment of the present invention will be described with reference to the drawings.

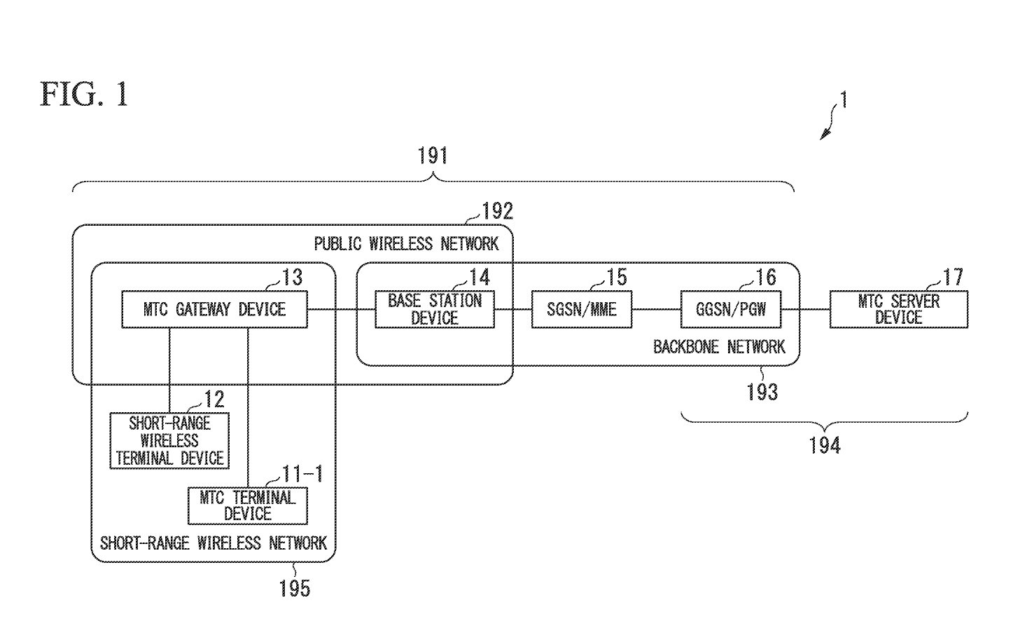

FIG. 1 is a schematic diagram showing a communication system 1 according to the present embodiment.

The communication system 1 includes an MTC terminal device 11-1, a short-range wireless terminal device 12, an MTC gateway device 13, a base station device 14, an SGSN/MME 15, a GGSN/PGW 16, and an MTC server device 17. These elements constitute a terrestrial public mobile network 191, a wide area network 194, and a short-range wireless network 195.

The terrestrial public mobile network 191 is a network that provides mobile communication services in public, and includes a public wireless network 192 and a backbone network 193. The terrestrial public mobile network 191 is a network based on, for example, an LTE (long term evolution) network. The public wireless network 192 is a radio access network (RAN) which wirelessly connects the base station device 14 and a terminal device (UE; user equipment), such as the MTC gateway device 13. The backbone network 193 is a network that connects, for example, the base station device 14, the SGSN/MME 15, and the GGSN/PGW 16 by, for example, wires. In the following description, connection occasionally means that communication can be performed by transmitting or receiving data, information, and signals, regardless of whether the connection is wired or wireless.

The backbone network 193 is also referred to as a core network (CN).

The wide area network 194 is a network that connects, for example, the GGSN/PGW 16, the MTC server device 17, and the like. The wide area network 194 is, for example, the Internet.

The short-range wireless network 195 is a small network that connects, under control of the MTC gateway device 13, the MTC terminal device 11-1 and the short-range wireless terminal device 12 within a relatively narrow area (for example, several meters to several ten meters). The short-range wireless network 195 is a network in which communication is performed by a method based on the standard, such as IEEE (institute of electrical and electronics engineers) 802.15.1 or IEEE 802.15.4. In addition to the communication ranges, frequency bands to be used for transmission and reception of signals are different between the public wireless network 192 and the short-range wireless network 195. In the short-range wireless network 195, the number of MTC terminals 11-1 and short-range wireless terminal devices 12 is not limited to one each, and the number of both terminals and devices may be more than one. Additionally, the short-range wireless network 195 may be configured to connect either one of the MTC terminal device 11-1 and the short-range wireless terminal device 12. In the following description, a plurality of, or an unspecified number of, MTC terminal devices are collectively referred to as an MTC terminal device 11 in some cases.

The MTC terminal device 11-1 has a configuration of transmitting and receiving data to and from the MTC server device 17 via the MTC gateway device 13 that will be described later. In addition to this configuration, the MTC terminal device 11-1 includes means for transmitting and receiving data to and from the MTC server device 17 via the base station device 14 that will be described later, without using the MTC gateway device 13. The MTC terminal device 11-1 is also referred to as an MTC device.

In the present embodiment, the MTC terminal device 11-1 transmits to the SGSN/MME 15 via the base station device 14, a gateway information request signal indicating a request for gateway information concerning the MTC gateway device 13. When the MTC terminal device 11-1 cannot be connected to the MTC gateway device 13, the MTC terminal device 11-1 transmits to the SGSN/MME 15 via the base station device 14, a gateway operation request signal that requests operation while regarding the MTC terminal device 11-1 as a gateway device. Thus, the MTC terminal device 11-1 also has a similar configuration to that of the MTC gateway device 13. In other words, the MTC terminal device 11-1 transmits to the base station device 14, data received from another terminal device (not shown), or transmits to another terminal device, data received from the base station device 14, thus transferring the data. When the MTC terminal device 11-1 can be connected to the MTC gateway device 13, the MTC terminal device 11-1 transmit or receive data concerning a given MTC service to and from the MTC server device 17 via the MTC gateway device 13. A configuration of the MTC terminal device 11-1 will be described later.

The short-range wireless terminal device 12 is a terminal device that transmits and receives data to and from the MTC server device 17 via the MTC gateway device 13. The short-range wireless terminal device 12 differs from the MTC terminal device 11-1 in that the short-range wireless terminal device 12 does not have the means for transmitting and receiving data to and from the MTC server device 17 via the base station device 14. The short-range wireless terminal device 12 is also referred to as a local access device. A configuration of the short-range wireless terminal device 12 will be described later.

The MTC gateway (MTC-GW) device 13 is a gateway device that connects the short-range wireless network 195 and the terrestrial public mobile network 191. In other words, the MTC gateway device 13 receives data transmitted by the MTC terminal device 11-1 or the short-range wireless terminal device 12 which is connected to the short range wireless network 195, and transmits the received data to the MTC server device 17 via the base station device 14. The MTC gateway device 13 transmits to at least one of the MTC terminal device 11-1 and the short-range wireless terminal device 12, the data received via the base station device 14 from the MTC server device 17. The data may be transmitted and received between the MTC terminal device 11-1 and the short-range wireless terminal 12, which are connected to the short range wireless network 195. Thus, the MTC gateway device 13 is a type of mobile station device that transmits and receives data via the base station device 14. The MTC gateway device 13 may include means for collecting or generating data, and means for transmitting the collected or generated data to the MTC server device 17 via the base station device 14. The configuration of the MTC gateway device 13 will be described later.

The base station device 14 transmits to a destination device (MTC server device 17 in the example shown in FIG. 1), data wirelessly received from the MTC gateway device 13 and other wireless terminal devices. The base station device 14 wirelessly transmits to the MTC gateway device 13 and other wireless terminal devices, data received from the destination device. The base station device 14 is, for example, an outdoor LTE (long term evolution) wireless base station device (eNodeB). A radius of the area where the base station device 14 can communicate with the MTC gateway device 13 and other terminal devices is, for example, several hundred meters to several kilometers, which is larger than the short range wireless network 195.

The base station device 14 generates a synchronization signal indicating base station device information (e.g., cell ID) that identifies the base station device 14. The base station device 14 wirelessly transmits the generated synchronization signal to terminal devices (including the MTC terminal device 11 and the MTC gateway 13) at a predetermined interval (e.g., 80 ms).

The base station device 14 receives an MTC gateway information request signal that requests MTC gateway information from the MTC terminal device 11, and transmits the MTC gateway information request signal to the SGSN/MME 15. The base station device 14 receives the MTC gateway information from the SGSN/MME 15, and transmits the received MTC gateway information to the MTC terminal device 11. The MTC gateway information is information concerning the MTC gateway device 13 relaying signals transmitted or received by the MTC terminal device 11. The MTC gateway information includes, addresses and the like, as identification information that identifies the MTC gateway information.

The base station device 14 transmits to the SGSN/MME 15, a registration request signal received from terminal devices (e.g., a mobile phone, which is not shown) other than the MTC terminal device 11 and the MTC gateway device 13, or an MTC-GW operation request signal received from the MTC gateway device 13. The registration request signal is a signal that requests registration of a device as a device to perform communication. The MTC-GW operation request signal is a signal that requests that the MTC terminal device 11 operate as a MTC gateway device.

The base station device 14 receives channel information from the SGSN/MME 15. The received channel information is information indicating a channel (bearer) between the base station device 14 and the GGSN/PGW 16. The base station device 14 transmits to the destination device through that channel, data received from a terminal device, and receives data from the destination device through the channel.

The base station device 14 receives an MTC-GW operation response signal from the SGSN/MME 15, and transmits to the MTC gateway device 13, the received MTC-GW operation response signal. The MTC-GW operation response signal is a signal indicating whether the MTC terminal device 11 can operate (“operable”), or cannot operate (“inoperable”), as a gateway device MTC. Here, the MTC gateway device indicated by the MTC-GW operational response signal may indicate an MTC terminal device 11 that operates (or tries to operate) as an MTC gateway device. The base station device 14 receives a registration acceptance signal from the SGSN/MME 15, and transmits the received registration acceptance signal to the terminal device having transmitted the registration request signal. The registration acceptance signal is a signal indicating that a registration request signal has been accepted. The terminal device to be a destination of the registration request signal does not include the MTC gateway device 13 and the MTC terminal device 11 that operates (or tries to operate) as an MTC gateway device.

The SGSN/MME 15 includes an SGSN (serving general packet radio service support node, which is also referred to as a packet processing node or a relay packet exchanger) and an MME (mobility management entity, mobile management device).

The SGSN/MME 15 stores base station device information that identifies the base station device 14, and gateway information concerning the MTC gateway device 13 connected to the base station device 14, while associating those information with each other. The SGSN/MME 15 receives from the MTC terminal device 11 via the base station device 14, a gateway request signal that requests gateway information, and transmits to the MTC terminal device 11, gateway information concerning the base station device 14 relaying the gateway request signal. When the SGSN/MME 15 receives from the MTC terminal device 11 via the base station device 14, an operation request signal indicating that requests a device to operate as a gateway device, the SGSN/MME 15 stores gateway information concerning the MTC terminal device 11, in association with the base station device information.

The SGSN/MME 15 receives a registration request signal via the base station device 14 from another terminal device other than the MTC terminal device 11. The SGSN/MME 15 stores mobile station device identification information that identifies the mobile station device having received the registration request signal, and base station device identification information that identifies the base station device relaying the registration request signal, while associating those information with each other. The SGSN/MME 15 generates channel information indicating a channel between the GGSN/PGW 16 and the base station device 14 having received the registration request signal or the gateway request signal, and transmits the generated channel information to the base station device 14. A configuration of the SGSN/MME 15 will be described later. Here, in the present embodiment, the MME and the SGSN may be independently configured, instead of being integrated.

The GGSN/PGW 16 includes a GGSN (gateway general packet radio service support Node, gateway packet switcher) and a PGW (packet data network gateway, packet data network gateway, packet data network gateway device). The GGSN/PGW 16 transmits data received from the base station device 14, to a destination device connected to the wide area network 194. The GGSN/PGW 16 transmits to the base station device 14, the data received from the destination device connected to the wide area network 194. Here, in the present embodiment, the PGW and the GGSN may be independently configured, instead of being integrated.

The MTC server device 17 aggregates and stores data received from the GGSN/PGW 16, that is, data generated or obtained by the MTC terminal device 11-1 and the short-range wireless terminal device 12. The MTC server device 17 has a functional unit that performs processing on the stored data. For example, in a case where retrieved data indicates a value of measurement performed by a temperature sensor included in the MTC terminal device 11-1 or the short-range wireless terminal device 12, the MTC server device 17 may include a data editing unit that edits the measured value, a data display unit that illustrates the measured value edited, and the like.

Next, the MTC terminal device 11 according to the present embodiment will be described. Hereinafter, descriptions will be given taking as an example a case where data generated by the MTC terminal device 11 is transmitted to the MTC server device 17.

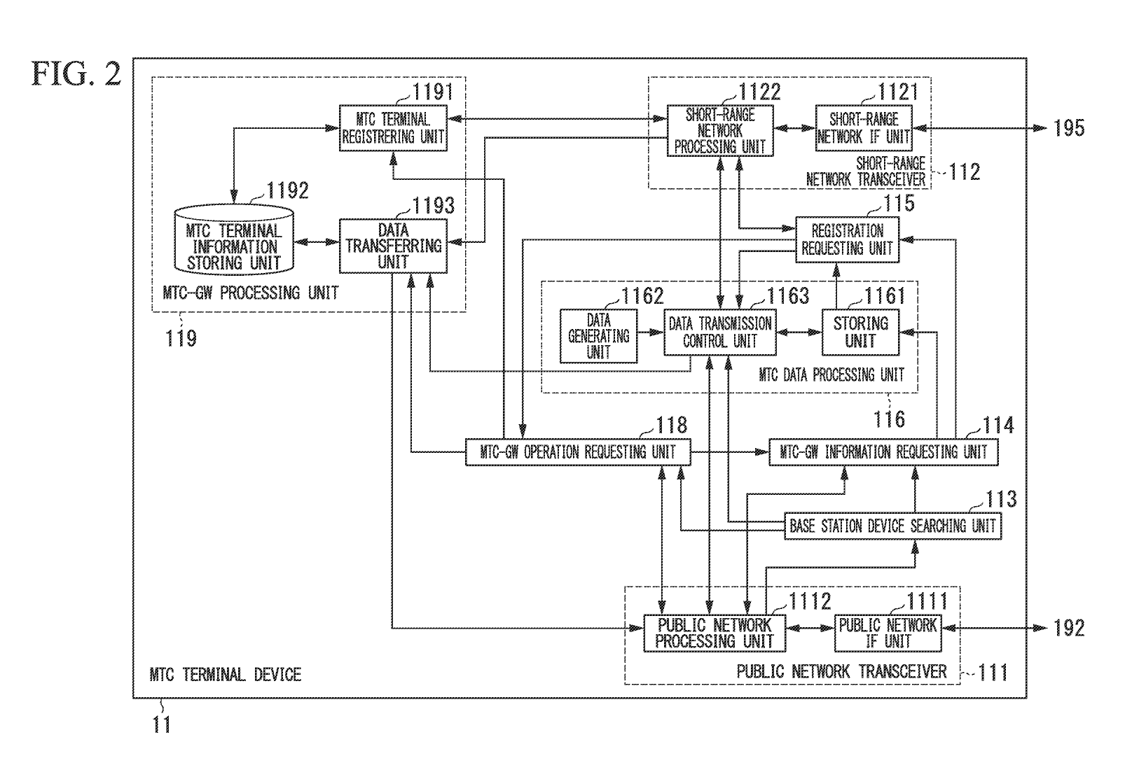

FIG. 2 is a schematic diagram showing a configuration of the MTC terminal device 11 according to the present embodiment.

The MTC terminal device 11 includes a public network processing unit 111, a short-range network transceiver 112, a base station device searching unit 113, an MTC-GW information requesting unit 114, a registration requesting unit 115, an MTC data processing unit 116, an MTC-GW operation requesting unit 118, and an MTC-GW processing unit 119.

The public network transceiver unit 111 includes a public network IF (interface) unit 1111 and a public network processing unit 1112.

The public network IF unit 1111 is an interface (e.g., an antenna) that wirelessly transmits and receives signals to and from the base station device 14. The public network IF unit 1111 transmits to the base station device 14 via the public wireless network 192, a transmission signal in a radio frequency band received from the public network processing unit 1112. The public network IF unit 1111 receives a reception signal in a radio frequency band from the base station device 14 via the public wireless network 192. The public network IF unit 1111 outputs to the public network processing unit 1112, the received reception signal in the radio frequency band.

The public network processing unit 1112 coverts (down-converts) the reception signal in the radio frequency band received from the public network IF unit 1111, into a reception signal in a base band frequency. The public network processing unit 1112 outputs the converted reception signal to the base station device searching unit 113, the MTC-GW information requesting unit 114, the MTC data processing unit 116, or the MTC-GW operation requesting unit 118.

The public network processing unit 1112 receives a transmission signal from the MTC-GW information requesting unit 114, the MTC data processing unit 116, the MTC-GW operation requesting unit 118, or the MTC-GW processing unit 119. The public network processing unit 1112 converts (up-converts) the received transmission signal in the base frequency band into a transmission signal in the radio frequency band.

The public network processing unit 1112 outputs to the public network IF unit 1111, the converted transmission signal in the radio frequency band.

The short-range network transceiver unit 112 includes a short-range network IF unit 1121 and a short-range network processing unit 1122.

The short-range network IF 1121 is an interface (e.g., an antenna) that wirelessly transmits and receives signals to and from another MTC terminal device 11, the short-range wireless terminal device 12, or the MTC gateway device 13. The short-range network IF unit 1121 transmits the transmission signal in the radio frequency band received from the short-range network processing unit 1122, via the short-range wireless network 195, to the other MTC terminal device 11, the short-range wireless terminal device 12, or the MTC gateway device 13. The short-range network IF unit 1121 receives the reception signal in the radio frequency band via the short-range wireless network 195 from the other MTC terminal device 11, the short-range wireless terminal device 12, or the MTC gateway device 13. The short-range network IF unit 1121 outputs to the short-range network processing unit 1122, the received reception signal in the radio frequency band.

The short-range network processing unit 1122 converts the reception signal in the radio frequency band received from the short-range network IF unit 1121, into a reception signal in the base frequency band. The short-range network processing unit 1122 outputs the converted reception signal to the registration requesting unit 115, the MTC data processing unit 116, or the MTC-GW processing unit 119.

The short-range network processing unit 1122 receives a transmission signal from the registration requesting unit 115, the MTC data processing unit 116, or the MTC-GW processing unit 119. The short-range network processing unit 1122 converts the received transmission signal in the base frequency band into a transmission signal in the radio frequency band. The short-range network processing unit 1122 outputs the converted transmission signal in the radio frequency band to the short-range network IF unit 1121.

The base station device searching unit 113 receives from the public network processing unit 1112, a synchronization signal as the reception signal received from the base station device 14. The base station device searching unit 113 retrieves from the received synchronization signal, base station device information (e.g., cell ID) that identifies a base station device, and thus searches accessible base station devices (cell search). The base station device searching unit 113 outputs the retrieved base station device information to the MTC-GW information requesting unit 114, the MTC data processing section 116, and the MTC-GW operation requesting unit 118.

If the MTC-GW information requesting unit 114 does not have MTC gateway information, the MTC-GW information requesting unit 114 generates an MTC gateway information request signal that requests the MTC gateway information from the SGSN/MME 15. The MTC-GW information requesting unit 114 outputs to the public network processing unit 1112, the generated MTC gateway information request signal as a transmission signal addressed to the SGSN/MME 15. Here, at the time of the transmission to the SGSN/MME 15, the MTC gateway information request signal is relayed by the base station device 14 indicated by the base station device information received from the base station device searching unit 113.

The MTC-GW information requesting unit 114 receives from the public network processing unit 1112, the MTC gateway information as a reception signal received from the SGSN/MME 15 via the base station device 14. The MTC gateway information includes information concerning the MTC gateway device 13 to relay data generated by the MTC terminal device (MTC terminal device 11), such as identification information of the MTC gateway device 13.

The MTC-GW information requesting unit 114 outputs the received MTC gateway information to the MTC data processing unit 116 and the registration requesting unit 115.

Here, if the MTC gateway information is not received even after a predetermined time (e.g., 90 seconds) elapses from the time the MTC gateway information request signal is output (time-out), the MTC-GW information requesting unit 114 generates MTC gateway reception failure information. The MTC gateway reception failure information is information indicating that reception of MTC gateway information has failed. The MTC-GW information requesting unit 114 outputs the generated MTC gateway reception failure information to the MTC data processing unit 116 and the registration requesting unit 115.

The registration requesting unit 115 generates an MTC terminal registration request signal that requests the MTC gateway device 13 to register the MTC terminal device (MTC terminal device 11) as a device to perform communication via the short-range wireless network 195 that is under the control of the MTC gateway device 13. The MTC terminal registration request signal includes device identification information that identifies the MTC terminal device 11 (e.g., MAC address). The registration requesting unit 115 outputs to the short-range network processing unit 1122, the generated MTC terminal registration request signal as a transmission signal addressed to the MTC gateway device 13. Here, the registration requesting unit 115 identifies the MTC gateway device 13 using the MTC gateway information received from the MTC-GW information requesting unit 114.

The registration requesting unit 115 receives from the short-range network processing unit 1122, an MTC terminal registration response signal as a reception signal received from the MTC gateway device 13. The MTC terminal registration response signal is a signal indicating whether a terminal device has been registered (success of registration) or has not been registered (failure of registration), as an MTC terminal device to perform communication in the short range wireless network 195. The registration requesting unit 115 outputs the received MTC terminal registration response signal to the MTC data processing unit 116. If the received MTC terminal registration response signal indicates failure of the registration, the registration requesting unit 115 outputs the MTC terminal registration response signal to the MTC-GW operation requesting unit 118.

Here, if MTC terminal registration response information is not received even after a predetermined time (e.g., 90 seconds) elapses from the time the MTC terminal registration request signal is output (time-out), the registration requesting unit 115 generates an MTC terminal registration response signal indicating failure of the registration. The registration requesting unit 115 outputs the generated MTC terminal registration response signal to the MTC-GW operation requesting unit 118.

Further, when the MTC gateway receives MTC gateway reception failure information from the MTC-GW information requesting unit 114, the registration requesting unit 115 outputs the MTC gateway reception failure information to the MTC-GW operation requesting unit 118.

The MTC data processing unit 116 includes a storing unit 1161, a data generating unit 1162, and a data transmission control unit 1163. The storing unit 1161 stores the MTC gateway information received from the MTC-GW information requesting unit 114.

The data generating unit 1162 generates data to be transmitted. For example, in a case where a service provided by the MTC is a temperature information providing service, the data generating unit 1162 generates temperature data indicating the measured temperature. The data generating unit 1162 outputs the generated data to the data transmission control unit 1163.

If the MTC terminal registration response signal received from the registration requesting unit 115 indicates success of the registration, the data transmission control unit 1163 reads the MTC gateway information from the storing unit 1161. The MTC terminal registration response signal received from the registration requesting unit 115 includes MTC terminal address information unique to the MTC terminal device (MTC terminal device 11-1), which is generated by the MTC gateway device 13. The data transmission control unit 1163 retrieves the MTC terminal address information from the received MTC terminal registration response signal. The data transmission control unit 1163 generates a data packet by adding to the data received from the data generating unit 1162, the retrieved MTC gateway information and MTC terminal address information as a header. The data transmission control unit 1163 outputs to the short-range network processing unit 1122, the generated data packet as a transmission signal to be relayed by the MTC gateway device 13 indicated by the read MTC gateway information.

If the MTC terminal registration response signal received from the registration requesting unit 115 indicates failure of the registration, the data transmission control unit 1163 outputs to the data transferring unit 1193, the data received from the data generating unit 1162. The data to be output becomes a transmission signal to be transmitted in a case where the MTC terminal device operates as an MTC gateway.

The data transmission control unit 1163 adds to the data received from the data generating unit 1162, the retrieved MTC terminal address information as transmission source address information. The data transmission control unit 1163 adds to the data added with the transmission source address information, address information of the MTC gateway device 13 included in the read MTC gateway information, as a relay address information. The data transmission control unit 1163 adds to the data added with the relay address information, address information of the MTC server device 17 as a destination device, as transmission destination address information. The data transmission control unit 1163 transmits via the short-range network transceiver 112, a data packet generated by adding those address information, as the above-described transmission signal addressed to the MTC gateway device 13.

When an MTC terminal registration response signal indicating failure of the registration or MTC gateway reception failure information is received from the registration requesting unit 115, the MTC-GW operation requesting unit 118 generates an MTC-GW operation request signal. The MTC-GW operation request signal is a signal that requests the SGSN/MME 15 that the MTC terminal device (MTC terminal device 11) operate as a MTC gateway device. The MTC gateway information includes identification information that identifies the MTC terminal device. The MTC-GW operation requesting unit 118 outputs to the public network processing unit 1112, the generated MTC-GW operation request signal as a transmission signal addressed to the SGSN/MME 15. Here, at the time of transmission to the SGSN/MME 15, the transmission signal is relayed by the base station device 14 indicated by the base station device information received from the base station device searching unit 113.

The MTC-GW operation requesting unit 118 receives from the public network processing unit 1112, an MTC-GW operation response signal as a reception signal received from the SGSN/MME 15. The MTC-GW operation response signal is a signal indicating whether a device can operate as an MTC gateway device (“operable”), or a device cannot operate as an MTC gateway device (“inoperable”). If the MTC-GW operation response signal indicates “operable”, the MTC-GW operation requesting unit 118 generates a process initiation signal indicating initiation of a process, and includes therein the base station device information received from the base station device searching unit 113. The MTC-GW operation requesting unit 118 outputs the generated process initiation signal to the MTC-GW processing unit 119.

Here, operation of the MTC-GW operation requesting unit 118, which is to be performed if an MTC-GW operation response signal indicating “inoperable” is received, or if an MTC-GW operation response signal is not received even after a predetermined time (e.g., 90 seconds) elapses from the time an MTC-GW operation request signal is output (time-out), will be described later.

The MTC-GW processing unit 119 includes an MTC terminal registering unit 1191, an MTC terminal information storing unit 1192, and a data transferring unit 1193. Hereinafter, descriptions will be given taking mainly as an example a process to be performed on signals transmitted to and received from another MTC terminal device 11. However, the MTC-GW processing unit 119 performs a similar process on signals transmitted to and received from the short-range wireless terminal device 12.

The MTC terminal registering unit 1191 receives from the short-range network processing unit 1122, an MTC terminal registration request signal as a reception signal received from another MTC terminal device 11.

The MTC terminal registering unit 1191 generates MTC terminal address information different from the MTC terminal address information stored in the MTC terminal registering unit 1191. Thus, the address information unique to the other MTC terminal device 11 is generated. The MTC terminal registering unit 1191 retrieves device identification information from the received MTC terminal registration request signal, and stores in the MTC terminal information storing unit 1192, the retrieved device identification information in association with the generated MTC terminal address information. The MTC terminal registering unit 1191 generates an MTC terminal registration response signal including the generated MTC terminal address information. The MTC terminal registering unit 1191 outputs to the short-range network processing unit 1122, the generated MTC registration response signal as a transmission signal addressed to the other MTC terminal device 11.

The data transmitting unit 1193 receives from the short-range network processing unit 1122, a data packet as a reception signal from the other MTC terminal device 11. The data transferring unit 1193 retrieves the MTC terminal address information as transmission source address information included in the received data packet, and determines whether the retrieved MTC terminal address information is stored in the MTC terminal information storing unit 1192. If the retrieved MTC terminal address information is stored in the MTC terminal information storing unit 1192, it is indicated that the received data packet is a reception signal received from the other MTC terminal device 11 previously registered. If the received data packet includes address information of the MTC terminal device (MTC terminal device 11) as relay address information, the data transmitting unit 1193 removes the address information of the MTC terminal device from the data packet.

If the retrieved MTC terminal address information is stored in the MTC terminal information storing unit 1192, the data transferring unit 1193 outputs to the public network processing unit 1112, the received data packet as a transmission signal to be relayed by the base station device 14.

The data transferring unit 1193 generates a data packet by adding to the data received from the data transmission control unit 1163, header information including MTC terminal address information of the MTC terminal device as transmission source address information. The data transferring unit 1193 outputs to the public network processing unit 1112, the generated data packet as a transmission signal to be relayed by the base station device 14.

The data transferring unit 1193 identifies the base station device 14 using the address information indicated by the base station device information retrieved from the process initiation signal received from the MTC-GW operation requesting unit 118. If a process initiation signal is not received from the MTC-GW operation requesting unit 118, the data transferring unit 1193 does not output the data packet to the public network processing unit 1112.

Next, a configuration of the short-range wireless terminal device 12 will be described.

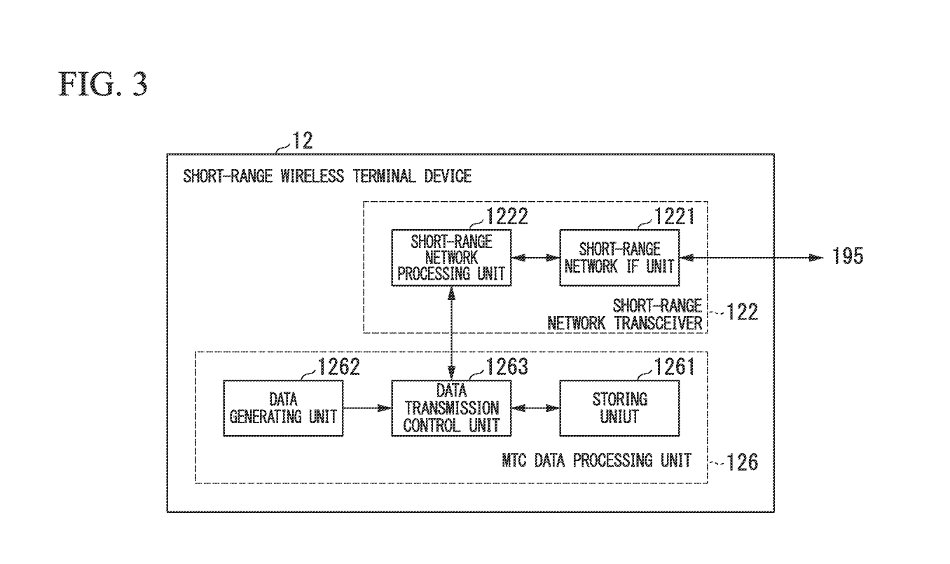

FIG. 3 is a schematic diagram showing a configuration of a short-range wireless terminal device 12 according to the present embodiment. The short-range wireless terminal device 12 includes a short-range network transceiver 122 and an MTC data processing unit 126. The short-range network transceiver unit 122 includes a short-range network IF unit 1221 and a short-range network processing unit 1222. The short-range network IF unit 1221 and the short-range network processing unit 1222 have similar configurations respectively to those of the short-range network IF unit 1121 and the short-range network processing unit 1122 described above.

In other words, the short-range network IF unit 1221 transmits a transmission signal in the radio frequency band received from the short-range network processing unit 1222, via the short-range wireless network 195 to the MTC terminal device 11, another short-range wireless terminal device 12 (considering a case where there are a plurality of short-range wireless terminal devices 12, those short-range wireless terminal devices 12 are collectively referred to as “another short-range wireless terminal device 12”), or the MTC gateway device 13.

The short-range network IF unit 1221 receives a reception signal in the radio frequency band via the short-range wireless network 195 from the MTC terminal device 11, the other short-range wireless terminal device 12, or the MTC gateway device 13. The short-range network IF unit 1221 outputs the received reception signal in the radio frequency band to the short-range network processing unit 1222.

The short-range network processing unit 1222 converts the reception signal in the radio frequency band received from the short-range network IF unit 1221, into a reception signal in a base frequency band. The Short-range network processing unit 1222 outputs the converted reception signal to the MTC data processing unit 126.

The short-range network processing unit 1222 receives a transmission signal from the MTC data processing unit 126. The short-range network processing unit 1222 converts the received transmission signal in the base frequency band into a transmission signal in the radio frequency band. The short-range network processing unit 1222 outputs the converted transmission signal in the radio frequency band into the short-range network IF unit 1221.

The MTC data processing unit 126 includes a storing unit 1261, a data generating unit 1262, and a data transmission control unit 1263. The storing unit 1261, the data generating unit 1262, and the data transmission control unit 1263 have similar configurations respectively to those of the storing unit 1161, the data generating unit 1162, and the data transmission control unit 1163 (FIG. 2) described above.

The storing unit 1261 previously stores MTC gateway information.

The data generating unit 1262 generates data to be transmitted. The data generating unit 1262 outputs the generated data to the data transmission control unit 1263.

The data transmission control unit 1263 reads the MTC gateway information from the storing unit 1261. The data transmission control unit 1263 outputs to the short-range network processing unit 1222, the data received from the data generating unit 1262 as a transmission signal to be relayed by the MTC gateway device 13 indicated by the read MTC gateway information.

Before transmitting the generated data to the MTC gateway device 13, the data transmission control unit 1263 generates an MTC terminal registration request signal. The data transmission control unit 1263 outputs to the short-range network processing unit 1222, the generated MTC terminal registration request signal as a transmission signal addressed to the MTC gateway device 13.

The data transmission control unit 1263 receives from the short-range network processing unit 1222, an MTC terminal registration response signal as a reception signal received from the MTC gateway device 13. The data transmission control unit 1263 retrieves the MTC terminal address information from the received MTC terminal registration response signal.

The data transmission control unit 1263 adds to the data received from the data generating unit 1262, the retrieved MTC terminal address information as transmission source address information. The data transmission control unit 1263 adds to the data added with the transmission source address information, address information of the MTC gateway device 13 included in the read MTC gateway information, as relay address information. The data transmission control unit 1263 adds to the data added with the relay address information, address information of the MTC server device 17 as the destination device, as transmission destination address information. The data transmission control unit 1263 transmits a data packet generated by adding those address information thereto, as a transmission signal addressed to the above MTC gateway device 13.

Next, a configuration of the MTC gateway device 13 will be described.

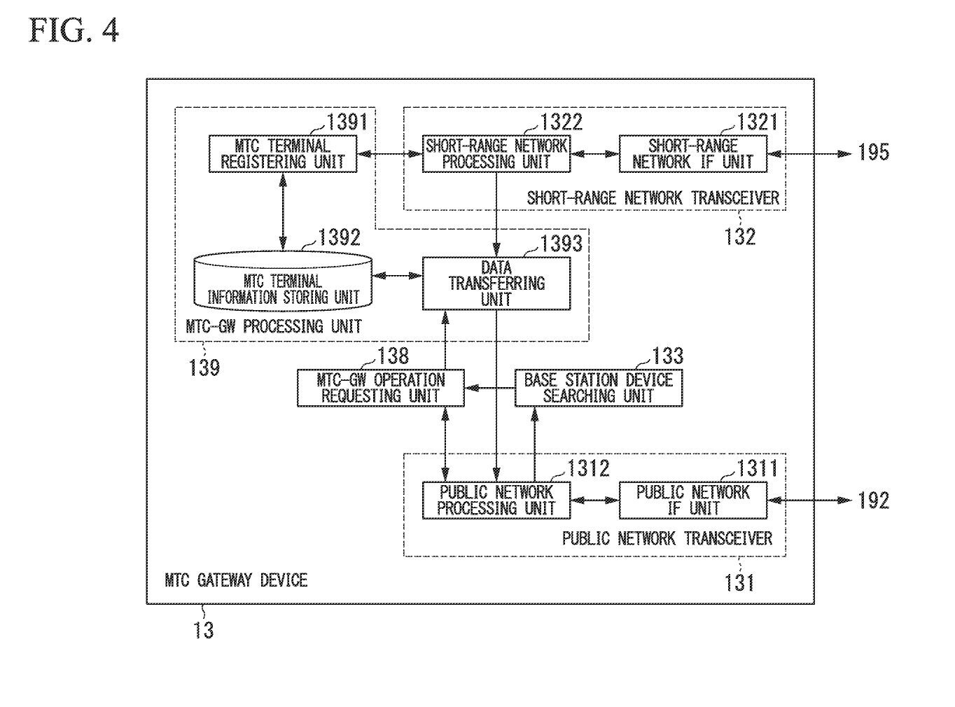

FIG. 4 is a schematic diagram showing the configuration of the MTC gateway device 13 according to the present embodiment.

The MTC gateway device 13 includes a public network transceiver 131, a short-range network transceiver 132, a base station device searching unit 133, an MTC-GW operation requesting unit 138, and an MTC-GW processing unit 139.

The public network transceiver unit 131 includes a public network IF unit 1311 and a public network processing unit 1312. The public network IF unit 1311 and the public network processing unit 1312 have similar configurations respectively to those of the public network IF unit 1111 and the public network processing unit 1112 (FIG. 2) described above.

In other words, the public network IF unit 1311 transmits to the base station device 14 via the public wireless network 192, the transmission signal in the radio frequency band received from the public network processing unit 1312. The public network IF unit 1311 receives a reception signal in the radio frequency band from the base station device 14 via the public wireless network 192. The public network IF unit 1311 outputs the received reception signal in the radio frequency band to the public network processing unit 1312.

The public network processing unit 1312 converts the reception signal in the radio frequency band received from the public network IF unit 1311, into a reception signal in the base frequency band. The public network processing unit 1312 outputs the converted reception signal to the base station device searching unit 133 or the MTC-GW operation requesting unit 138.

The public network processing unit 1312 receives a transmission signal from the MTC-GW operation requesting unit 138 or the MTC-GW processing unit 139. The public network processing unit 1312 converts the received transmission signal in the base frequency band into a transmission signal in the radio frequency band. The public network processing unit 1312 outputs to the public network IF unit 1311, the converted transmission signal in the radio frequency band.

The short-range network transceiver unit 132 includes a short-range network IF unit 1321 and a short-range network processing unit 1322. The short-range network IF unit 1321 and the short-range network processing unit 1322 have similar configurations respectively to those of the short-range network IF unit 1121 and the short-range network processing unit 1122 described above.

In other words, the short-range network IF unit 1321 transmits to the MTC terminal device 11 or the short-range wireless terminal device 12 via the short range wireless network 195, the transmission signal in the radio frequency band received from the short-range network processing unit 1322. The short-range network IF unit 1321 outputs to the short-range network processing unit 1322, the reception signal in the radio frequency band received via the short-range wireless network 195 from the MTC terminal device 11 or the short-range wireless terminal device 12.

The short-range network processing unit 1322 converts the reception signal in the radio frequency band received from the short-range network IF unit 1121, into a reception signal in the base frequency band. The short-range network processing unit 1322 outputs the converted reception signal to the MTC-GW processing unit 139.

The short-range network processing unit 1322 receives a transmission signal from the MTC-GW processing unit 139. The short-range network processing unit 1322 converts the received transmission signal in the base frequency band into a transmission signal in the radio frequency band. The short-range network processing unit 1322 outputs to the short-range network IF unit 1321, the converted transmission signal in the radio frequency band.

The base station device searching unit 133 has a similar configuration to that of the above-described base station device searching unit 113. In other words, the base station device searching unit 133 receives from the public network processing unit 1312, a synchronization signal as a reception signal received from the base station device 14. The base station device searching unit 133 retrieves base station device information that identifies the base station device from the received synchronization signal, and searches accessible base station devices. The base station device searching unit 133 outputs the retrieved base station device information to the MTC-GW operation requesting unit 138.

The MTC-GW operation requesting unit 138 has a similar configuration to that of the above-described MTC-GW operation requesting unit 118. The MTC-GW operation requesting unit 138 generates an MTC-GW operation request signal and outputs to the public network processing unit 1312, the generated MTC-GW operation request signal as a transmission signal addressed to the SGSN/MME 15. However, at the time of transmission to the SGSN/MME 15, the transmission signal is relayed by the base station device 14 indicated by the base station device information received from the base station device searching unit 133.

The MTC-GW operation requesting unit 138 receives from the public network processing unit 1312, the MTC-GW operation response signal as a reception signal received from the SGSN/MME 15. If the MTC-GW operation response signal is a signal indicating “operable”, the MTC-GW operation requesting unit 138 generates a process initiation signal indicating initiation of a process, and includes therein the base station device information received from the base station device searching unit 133. The MTC-GW operation requesting unit 138 outputs the generated process initiation signal to the MTC-GW processing unit 139.

The MTC-GW processing unit 139 includes an MTC terminal registering unit 1391, an MTC terminal information storing unit 1392, and a data transferring unit 1393. With respect to transmission and reception of signals to and from the short-range wireless terminal device 12, the MTC-GW processing unit 139 performs a similar process to transmission and reception of signals to and from the MTC terminal device 11.

The MTC terminal registering unit 1391, the MTC terminal information storing unit 1392, the data transferring unit 1393 have similar configurations respectively to those of the MTC terminal registering unit 1191, the MTC terminal information storing unit 1192, and the data transferring unit 1193 described above.

In other words, the MTC terminal registering unit 1391 receives from the short-range network processing unit 1322, an MTC terminal registration request signal as a reception signal received from the MTC terminal device 11.

The MTC terminal registering unit 1391 generates MTC terminal address information different from the MTC terminal address information stored in the MTC terminal registering unit 1391. The MTC terminal registering unit 1391 retrieves device identification information from the received MTC terminal registration request signal, and stores in the MTC terminal information storing unit 1392, the device identification information in association with the generated MTC terminal address information. The MTC terminal registering unit 1391 generates an MTC terminal registration response signal including the generated MTC terminal address information. The MTC terminal registering unit 1391 generates an MTC terminal registration response signal indicating that, for example, the device has been registered as an MTC terminal device (success of registration). However, if the device cannot be registered as an MTC terminal device, the MTC terminal registering unit 1391 generates an MTC terminal registration response signal indicating that the device is not registered as an MTC terminal device (failure of registration). Examples of the case where the device cannot be registered as an MTC terminal device include a case where the number of registered MTC terminal devices and registered short-range wireless terminals is greater or equal to the predetermined maximum registrable number. The MTC terminal registering unit 1391 outputs to the short-range network processing unit 1322, the generated MTC terminal registration response signal as a transmission signal addressed to the MTC terminal device 11.

The data transferring unit 1393 receives from the short-range network processing unit 1322, a data packet as a reception signal received from the MTC terminal device 11. The data transferring unit 1393 retrieves MTC terminal address information as transmission source address information included in the received data packet, and determines whether or not the retrieved MTC terminal address information is stored in the MTC terminal information storing unit 1392. If the received data packet includes address information of the MTC gateway device (MTC gateway device 13) as relay address information, the data transferring unit 1393 removes the address information of the MTC gateway device from the received data packet.

If the retrieved MTC terminal address information is stored in the MTC terminal information storing unit 1392, the data transferring unit 1393 outputs to the public network processing unit 1312, the received data packet as a transmission signal to be relayed by the base station device 14. The data transferring unit 1393 identifies the base station device 14 using the address information indicated by the base station device information retrieved from the process initiation signal received from the MTC-GW operation requesting unit 138.

Next, a configuration of the SGSN/MME 15 will be described.

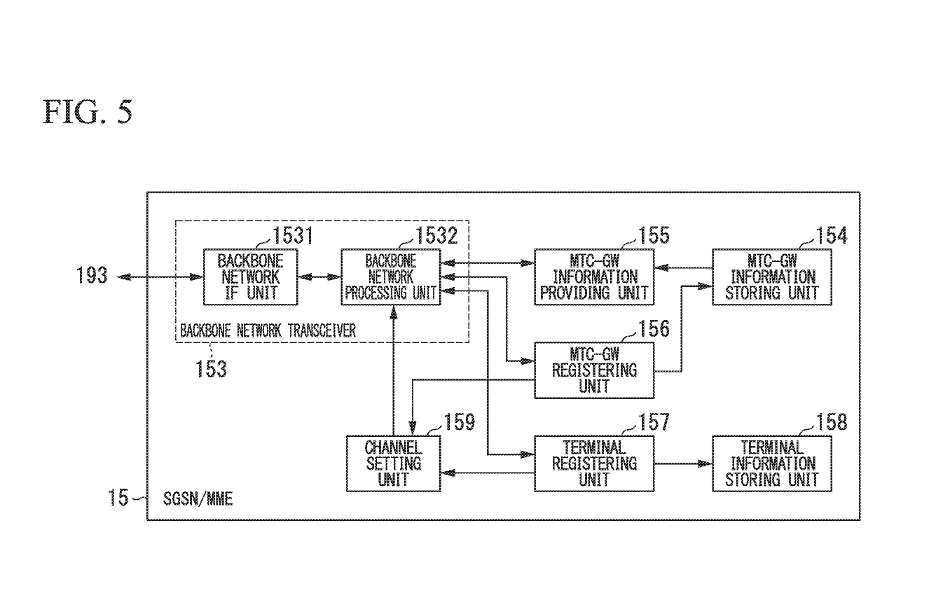

FIG. 5 is a schematic diagram showing the configuration of the SGSN/MME 15 according to the present embodiment.

The SGSN/MME 15 includes a backbone network transceiver unit 153, an MTC-GW information storing unit 154, an MTC-GW information providing unit 155, an MTC-GW registering unit 156, a terminal registering unit 157, a terminal information storing unit 158, and a channel setting unit 159. The backbone network transceiver unit 153 includes a backbone network IF unit 1531 and a backbone network processing unit 1532.

The backbone network IF unit 1531 is an input-output interface to establish connection to the backbone network 193. The backbone network IF unit 1531 transmits a transmission signal received from the backbone network processing unit 1532, via the backbone network 193 to a device connected to the communication network, such as the base station device 14 or the GGSN/PGW 16. The backbone network IF unit 1531 outputs via the backbone network 193 to the backbone network processing unit 1532, a reception signal received from the device connected to the communication network.

The backbone network processing unit 1532 converts into a predetermined format, a transmission signal received from the MTC-GW information providing unit 155, the MTC-GW registering unit 156, the terminal registering unit 157, or the channel setting unit 159, and outputs the converted transmission signal to the backbone network IF unit 1531. The predetermined format is a format for transmitting and receiving a transmission signal in the backbone network 193, such as an optical signal. The backbone network processing unit 1532 converts into another format, the reception signal in the predetermined format received from the backbone network IF unit 1531. The backbone network processing unit 1532 outputs the converted signal to the MTC-GW information providing unit 155, the MTC-GW registering unit 156, or the terminal registering unit 157. The other format is a format in which the MTC-GW information providing unit 155, the MTC-GW registering unit 156, or the terminal registering unit 157 can process a reception signal.

The MTC-GW information storing unit 154 stores MTC gateway information and the base station device information which are associated with each other. The base station device information is associated MTC gateway information indicating an MTC gateway device present within a cell served by the base station device indicated by the base station device information. The cell is an area where a terminal device (also including the MTC gateway device 13) can wirelessly communicate with the base station device.

The MTC-GW information providing unit 155 receives from the backbone network processing unit 1532, an MTC gateway information request signal as a reception signal received via the base station device 14 from the MTC terminal device 11. The MTC-GW information providing unit 155 reads from the MTC-GW information storing unit 154, the MTC gateway information associated with the base station device information indicating the base station device 14 relaying the MTC gateway information request signal. The MTC-GW information providing unit 155 outputs to the backbone network processing unit 1532, the read MTC gateway information as a transmission signal to be transmitted to the MTC terminal device 11 via the base station device 14.

The MTC-GW registering unit 156 receives from the backbone network processing unit 1532, an MTC-GW operation request signal as a reception signal received from the MTC terminal device 11 via the base station device 14. The MTC-GW registering unit 156 retrieves the MTC gateway information from the received MTC-GW operation request signal. The MTC-GW registering unit 156 stores in the MTC-GW information storing unit 154, the retrieved MTC gateway information in association with the base station device information indicating the base station device 14 relaying the MTC-GW operation request signal.

The MTC-GW registering unit 156 generates an MTC-GW operation response signal indicating that the MTC terminal device 11 can operate as an MTC gateway device (“operable”). The MTC-GW registering unit 156 outputs to the backbone network processing unit 1532, the generated MTC-GW operation response signal as a transmission signal to be transmitted to the MTC terminal device 11 via the base station device 14. The MTC-GW registering unit 156 outputs the received MTC-GW operation request signal to the channel setting unit 159.

Here, if the MTC terminal device 11 cannot operate as an MTC gateway device, the MTC-GW registering unit 156 generates an MTC-GW operation response signal indicating that the MTC terminal device cannot operate as an MTC gateway device (“inoperable”). Examples of the case where the MTC terminal device 11 cannot operate as an MTC gateway device include a case where the number of terminal devices (also including the MTC terminal device 11 and the MTC gateway device 13) registered to the base station device 14 relaying the MTC-GW operation request signal is greater than or equal to the maximum registrable number.

The terminal registering unit 157 receives from the backbone network processing unit 1532, a registration request signal as a reception signal received via the base station device 14 from another terminal device (which is not shown and does not include the MTC terminal device 11 and the MTC gateway device 13). The terminal registering unit 157 retrieves from the received registration request signal, terminal information that identifies the transmission source terminal device. The terminal registering unit 157 stores in the terminal information storing unit 158, the retrieved terminal information in association with the base station device information indicating the base station device 14 relaying the registration request signal. The terminal registering unit 157 generates a registration acceptance signal indicating that the registration request signal has been accepted. The terminal registering unit 157 outputs to the backbone network processing unit 1532, the generated registration acceptance signal as a transmission signal to be transmitted to a terminal device (not shown) that has transmitted the registration request signal via the base station device 14.

The terminal registering unit 157 outputs the registration request signal to the channel setting unit 159.

The channel setting unit 159 receives the MTC-GW operation request signal from the MTC-GW registering unit 156, and receives the registration request signal from the terminal registering unit 157. The channel setting unit 159 generates channel information indicating a channel between the GGSN/PGW 16 and the base station device 14 having relayed the received MTC-GW operation request signal or the registration request signal. The channel setting unit 159 outputs to the backbone network processing unit 1532, the generated channel information as a transmission signal addressed to the base station device 14.

Next, a communication process to be performed by the communication system 1 according to the present embodiment will be described. Hereinafter, inputs and outputs between devices will be described with respect mainly to a process to be performed when a new MTC terminal device 11-2 (not shown in FIG. 1) is added to the communication system 1 shown in FIG. 1. The MTC terminal device 11-2 has a similar configuration to that of the MTC terminal device 11-1 (FIG. 2). Here, descriptions of processes to be performed by the public network transceiver units 111 (FIG. 2) and 131 (FIG. 4), and the short-range network transceiver units 112 (FIG. 1), 122 (FIG. 3), and 132 (FIG. 4), and the backbone network transceiver unit 153 (FIG. 5) are omitted here.

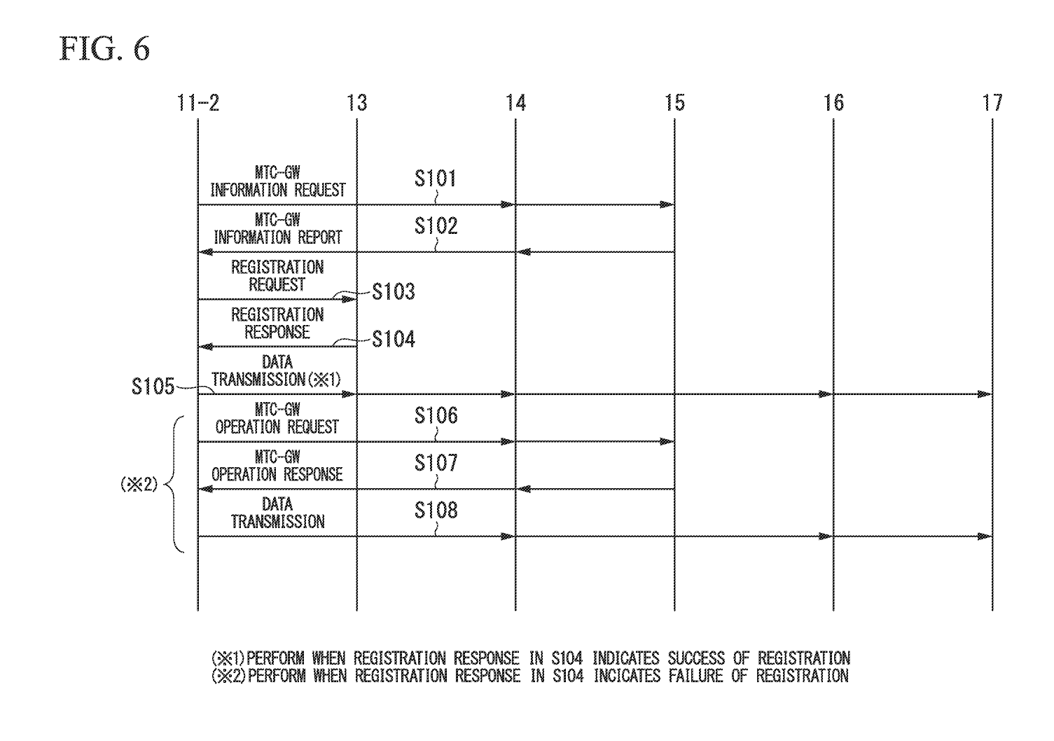

FIG. 6 is a sequence chart showing a communication process according to the present embodiment.

(Step S101) The base station device searching unit 113 of the MTC terminal device 11-2 retrieves the base station device information that identifies the base station device based on the reception signal received from the base station device 14 (step S101), and searches accessible base station devices.

The MTC-GW information requesting unit 114 of the MTC terminal device 11-2 generates an MTC gateway information request signal, and transmits the generated MTC gateway information request signal to the SGSN/MME 15 via the base station device 14 detected by search.

The MTC-GW information providing unit 155 of the SGSN/MME 15 receives the MTC gateway information request signal from the MTC terminal device 11 via the base station device 14. Thereafter, the process proceeds to step S102.

(Step S102) The MTC-GW information providing unit 155 of the SGSN/MME 15 reads from the MTC-GW information storing unit 154, the MTC gateway information associated with the base station device information indicating the base station device 14 having relayed the MTC gateway information request. The MTC-GW information providing unit 155 transmits via the base station device 14 to the MTC terminal device 11-2, the read gateway information as a transmission signal.

The MTC-GW information requesting unit 114 of the MTC terminal device 11-2 receives the MTC gateway information from the SGSN/MME 15. Thereafter, the process proceeds to step S103.

(Step S103) The registration requesting unit 115 of the MTC terminal device 11-2 generates an MTC terminal registration request signal and transmits the generated MTC terminal registration request signal to the MTC gateway device 13 indicated by the received MTC gateway information.

The MTC terminal registering unit 1391 of the MTC gateway device 13 receives the MTC terminal registration request signal from the MTC terminal device 11-2. Thereafter, the process proceeds to step S104.

(Step S104) The MTC terminal registering unit 1391 of the MTC gateway device 13 generates MTC terminal address information different from the MTC terminal address information stored in the MTC terminal registering unit 1391. The MTC terminal registering unit 1391 retrieves device identification information from the received MTC terminal registration request signal, and stores in the MTC terminal information storing unit 1392, the retrieved device identification information in association with the generated MTC terminal address information. The MTC terminal registering unit 1391 generates an MTC terminal registration response signal including the generated MTC terminal address information, and transmits the generated MTC terminal registration response signal to the MTC terminal device 11-2.

The data transmission control unit 1163 of the MTC terminal device 11-2 receives the MTC terminal registration response signal from the MTC gateway device 13. If the MTC terminal registration response signal indicates success of the registration, the process proceeds to step S105. If the MTC terminal registration response signal indicates failure of the registration, the process proceeds to step S106.

(Step S105) If the registration response signal received from the registration requesting unit 115 indicates success of the registration, the data transmission control unit 1163 of the MTC terminal device 11-2 reads MTC gateway information from the storing unit 1161. The data transmission control unit 1163 transmits the data received from the data generating unit 1162, to the MTC server device 17 via the MTC gateway device 13 indicated by the read MTC gateway information. Thereafter, the process is terminated.

(Step S106) The MTC-GW operation requesting unit 118 of the MTC terminal device 11-2 generates an MTC-GW operation request signal and transmits the generated MTC-GW operation request signal to the SGSN/MME 15 via the base station device 14.

The MTC-GW registering unit 156 of the SGSN/MME 15 receives the MTC-GW operation request signal from the MTC terminal device 11-2. The MTC-GW registering unit 156 of the SGSN/MME 15 retrieves MTC gateway information of the MTC terminal device 11-2 from the MTC-GW operation request signal. The MTC-GW registering unit 156 stores in the MTC-GW information storing unit 154, the retrieved MTC gateway information in association with the base station device information indicating the base station device 14 having relayed the MTC-GW operation request signal. Then, the process proceeds to step S107.

(Step S107) The MTC-GW registering unit 156 of the SGSN/MME 15 generates an MTC-GW operation response signal, and transmits the generated MTC-GW operation response signal to the MTC terminal device 11-2 via the base station device 14.

The MTC-GW operation request unit 118 of the MTC terminal device 11-2 receives the MTC-GW operational response signal from the SGSN/MME 15. Thereafter, the process proceeds to step S108.

(Step S108) If the MTC-GW operation response signal indicates “operable”, the data transferring unit 1193 of the MTC terminal device 11-2 transmits the data packet received from the other MTC terminal device 11, to the MTC server device 17 via the base station device 14.

Additionally, the data transmission control unit 1163 of the MTC terminal device 11-2 transmits the data received from the data generating unit 1162, to the MTC server device 17 via the base station device 14. Thereafter, the process is terminated.

Next, a communication process to be performed by the above-described MTC terminal device 11-2 will be described.

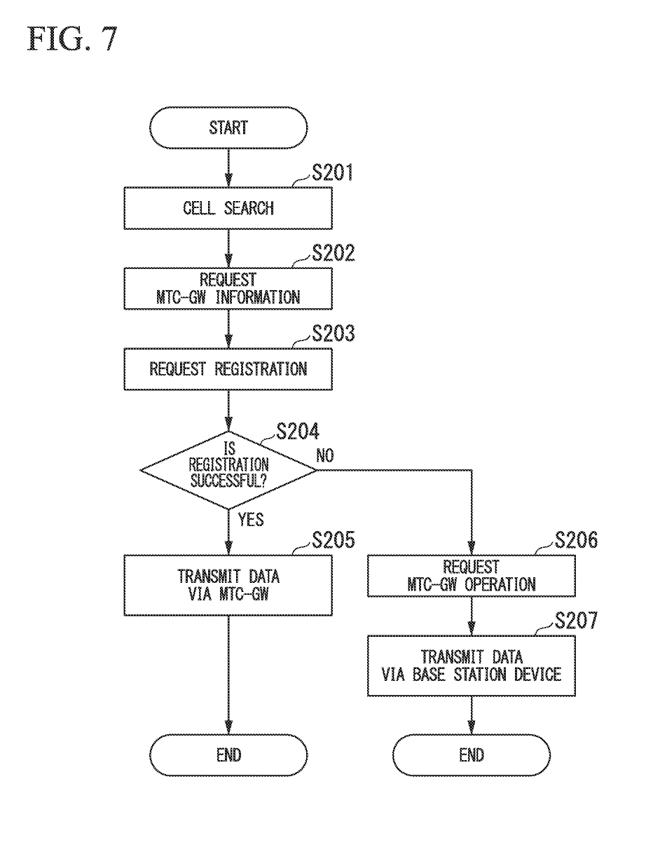

FIG. 7 is a flowchart showing a communication process to be performed by the MTC terminal device 11-2 according to the present embodiment.

(Step S201) The base station device searching unit 113 retrieves base station device information that identifies the base station device based on the reception signal received from the base station device 14, and searches accessible base station devices. Then, the process proceeds to step S202.

(Step S202) The MTC-GW information requesting unit 114 generates an MTC gateway information request signal and transmits the generated MTC gateway information request signal to the SGSN/MME 15 via the base station device 14 detected by the search.

The MTC-GW information requesting unit 114 receives the MTC gateway information from the SGSN/MME 15. Then, the process proceeds to step S203.

(Step S203) The registration requesting unit 115 generates an MTC terminal registration request signal, and transmits the generated MTC terminal registration request signal to the MTC gateway device 13 indicated by the received MTC gateway information. Thereafter, the process proceeds to step S204.

(Step S204) The data transmission control unit 1163 receives the MTC terminal registration response signal from the MTC gateway device 13 and determines whether or not the MTC terminal registration response signal indicates success of the registration. If it is determined that the MTC terminal registration response signal indicates success of the registration (step S204: Y), the process proceeds to step S205. If it is determined that the MTC terminal registration response signal indicates failure of the registration (step S204: N), the process proceeds to the step S206.

(Step S205) The data transmission control unit 1163 of the MTC terminal device 11-2 reads the MTC gateway information from the storing unit 1161. The data transmission control unit 1163 transmits the data received from the data generating unit 1162, to the MTC server device 17 via the MTC gateway device 13 indicated by the read MTC gateway information. Thereafter, the process is terminated.

(Step S206) The MTC-GW operation requesting unit 118 of the MTC terminal device 11-2 generates the MTC-GW operation request signal, and transmits the generated MTC-GW operation request signal to the SGSN/MME 15 via the base station device 14.

The MTC-GW operation request unit 118 of the MTC terminal device 11-2 receives the MTC-GW operational response signal from the SGSN/MME 15. Thereafter, the process proceeds to step S207.

(Step S207) If the MTC-GW operation response signal indicates “operable”, the data transferring unit 1193 of the MTC terminal device 11-2 transmits the data packet received from the other MTC terminal device 11, to the base station device 14 via the MTC server device 17.

Additionally, the data transmission control unit 1163 of the MTC terminal device 11-2 transmits the data received from the data generating unit 1162, to the MTC server device 17 via the base station device 14. Thereafter, the process is terminated.

Next, an aspect of the communication system 1, which is configured after the communication process shown in FIG. 6 or 7 is performed and which includes an additional MTC terminal device 11-2, will be described.

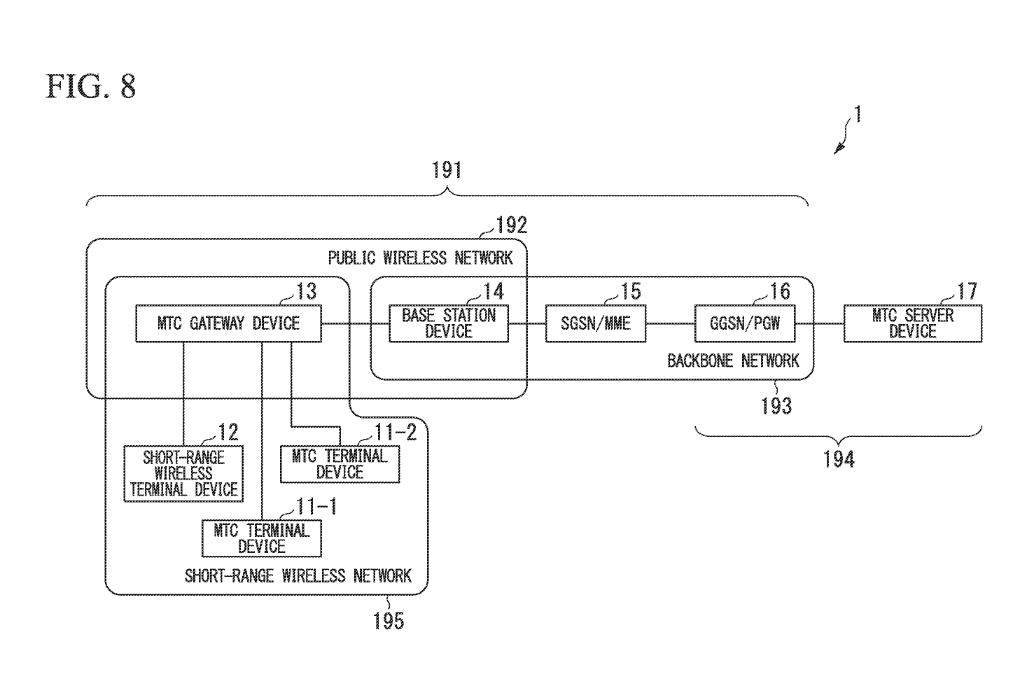

FIG. 8 is a schematic diagram showing another aspect of the communication system 1 according to the present embodiment.

The aspect shown in FIG. 8 is an aspect of the communication system 1 configured after step S105 shown in FIG. 6 or step S205 shown in FIG. 7 is performed.

The aspect shown in FIG. 8 differs from the aspect shown in FIG. 1 in that the MTC terminal device 11-2, in addition to the MTC gateway device 13, the short-range wireless terminal device 12, and the MTC terminal device 11-1, are connected to the short-range wireless network 195. Other respects are common to the aspect shown in FIG. 1.

Here, the MTC terminal device 11-2 is connected to the short-range wireless network 195 that is under the control of the MTC gateway device 13. The MTC terminal device 11-2 transmits the generated data to the MTC server device 17 via the MTC gateway device 13.

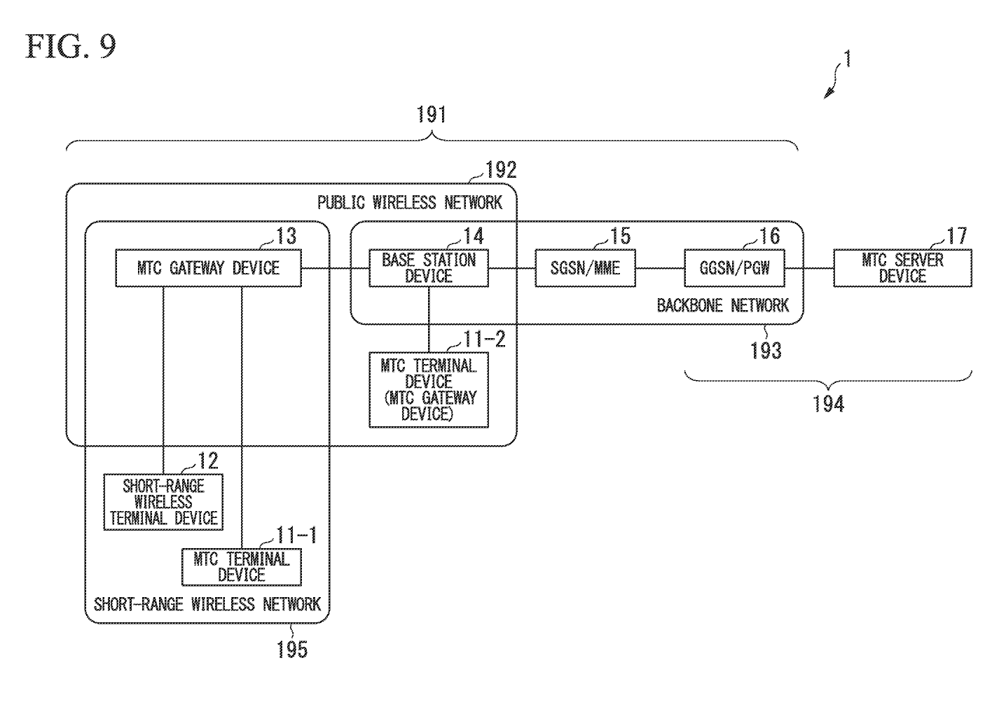

FIG. 9 is a schematic diagram showing a still another aspect of the communication system 1 according to the present embodiment.

The aspect shown in FIG. 9 is an aspect of the communication system 1 configured after step S108 shown in FIG. 6 or step S207 shown in FIG. 7 is performed.

The aspect shown in FIG. 9 differs from the aspect shown in FIG. 1 in that the MTC terminal device 11-2, in addition to the base station device 14 and the MTC gateway device 13, are connected to the public wireless network 192. Other respects are common to the aspect shown in FIG. 1. Here, the MTC terminal device 11-2 is connected to the public wireless network 192 that is under the control of the base station device 14. The MTC terminal device 11-2 transmits the generated data to the MTC server device 17 via the base station device 14.

In the aspect shown in FIG. 9, the MTC terminal device 11-2 operates as an MTC gateway device. In other words, there are some cases where the communication process shown in FIG. 6 or 7 is performed, and an additional other MTC terminal device 11-3 further participates in the network that is under the MTC terminal device 11-2.

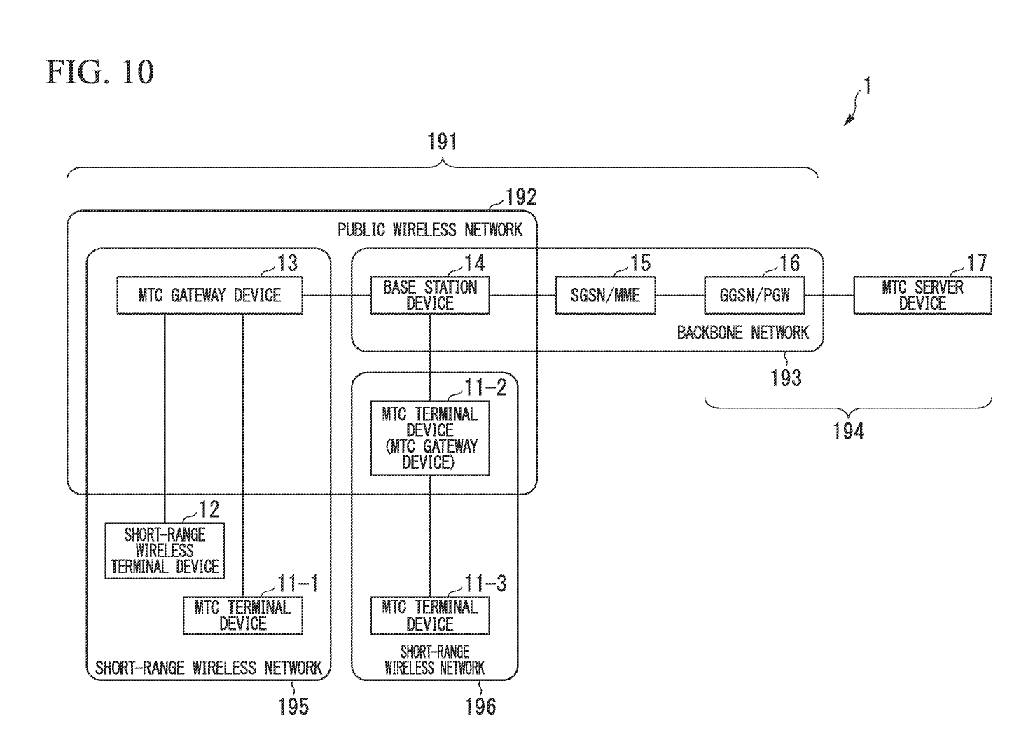

FIG. 10 is a schematic diagram showing a still yet another aspect of the communication system 1 according to the present embodiment.

Compared to the aspect shown in FIG. 9, an aspect shown in FIG. 10 is an aspect of the communication system 1 to be configured after step S105 shown in FIG. 6 or step S205 shown in FIG. 7 is performed.

The aspect shown in FIG. 10 differs from the aspect shown in FIG. 9 in that an MTC terminal device 11-3 is included in the communication system 1, and a short-range wireless network 196 is configured to connect the MTC terminal device 11-2 and the MTC terminal device 11-3. Other respects are common to the aspect shown in FIG. 9. Here, the MTC terminal device 11-3 is connected to the short-range wireless network 196 that is under the control of MTC terminal device 11-2. The MTC terminal device 11-3 transmits the generated data to the MTC server device 17 via the MTC terminal device 11-2 and the base station device 14.

Thus, in the present embodiment, if the MTC terminal device 11 cannot be connected to the short-range wireless network that is under the control of the MTC gateway device 13, the MTC terminal device 11 operates as an MTC gateway device. Thus, it is possible for the MTC terminal device 11 itself to ensure opportunities to transmit and receive data and easily configure a short-range wireless network connecting another MTC terminal device 11.

### Modified Example 1

Next, a first modified example of the present embodiment will be described.

In some cases, the above-described MTC-GW operation response signal indicates “inoperable”. Examples of those cases include a case where the MTC-GW registering unit 156 of the SGSN/MME 15 determines that the predetermined maximum number of mobile station devices that can be served by the base station device 14, and the maximum communication capacity of communication with the mobile station device, are exceeded, and a case where an index value representing the quality of communication with the MTC terminal device 11 is lower than a predetermined index value.

Additionally, examples of those cases include a case where an MTC-GW operation response signal is not received even after a predetermined time (e.g., 90 seconds) elapses from the time the MTC-GW operation requesting unit 118 of the MTC terminal device 11 outputs an MTC-GW operation request signal (time-out).

In such cases, the MTC terminal device 11 cannot transmit the generated data.

In the first modified example, the MTC-GW operation requesting unit 118 may repeat the process of generating and outputting the above-described operation request signal in a case where the MTC-GW operation response signal is the information indicating “incapable” or in a case where an MTC-GW operation response signal is not received. The MTC-GW operation requesting unit 118 may generate a repetitive signal indicating repetition of the process and output the generated repetitive signal to the MTC-GW information requesting unit 114. If a repetitive signal is received from the MTC-GW operation requesting unit 118, the MTC-GW information requesting unit 114 repeats the above-described process of generating and outputting an MTC gateway information request signal.

The MTC-GW operation requesting unit 118 counts the number of iterations, and terminates the process if the number of iterations exceeds a predetermined number of times (e.g., 5 times).

The number of iterations is predetermined, for example, five times. If this number of times is exceeded, the MTC-GW operation requesting unit 118 terminates the process.

In a case where the MTC-GW operation requesting unit 118 has the above-described configuration, steps S106 and S107 in the communication process shown in shown FIG. 6 is repeated a predetermined number of times. In the communication process shown in FIG. 7, the step S206 is repeated a predetermined number of times.

In the case where the MTC-GW operation requesting unit 118 is configured to generate a repetitive signal and outputs the repetitive signal to the MTC-GW information requesting unit 114, steps S101 to S107 in the communication process shown in FIG. 6 are repeated a predetermined number of times. Steps S202 to S206 in the communication process shown in FIG. 7 are repeated a predetermined number of times.

Thus, even when the MTC-GW operational response signal temporarily indicates “inoperable”, it is possible to reliably ensure opportunities for the MTC terminal device 11 to transmit and receive data, and easily configure a short-range wireless network that connects another MTC terminal device 11.

Here, although the description has been given above with respect to the case where the MTC-GW operation response signal indicates “inoperable”, the present embodiment is not limited thereto. In the present embodiment, the above-described repetitive process may be performed if an MTC-GW operation response signal is not received even after a predetermined time (e.g., 90 seconds) elapse from the time the MTC-GW operation request signal is output (timeout).

### Modified Example 2

Next, a second modified example of the present embodiment will be described.

MTC gateway information received by the MTC-GW information requesting unit 114 of the MTC terminal device 11-2 from the SGSN/MME 15 is not necessarily one piece of MTC gateway information concerning an MTC gateway device. In some cases, plural pieces of MTC gateway information each concerning an MTC gateway device are received. In such a case, from the plural pieces of MTC gateway information each concerning an MTC gateway device, the MTC-GW information requesting unit 114 selects one piece of MTC gateway information concerning an MTC gateway device, based on the selection criteria described below. Thus, it is possible to select an MTC gateway device, which can more reliably secure opportunities for the MTC terminal device 11 to transmit and receive data.

As a selection criterion, for example, any one of the following (1) to (4), or any combination thereof may be used.

(1) Select an MTC gateway device with the best communication quality.

The MTC-GW information requesting unit 114 receives a pilot signal to be transmitted by each MTC gateway device, and calculates an index value representing the communication quality based on the received pilot signal. Examples of the index value include an SINR (signal-to-interference noise power ratio), the reception strength, and the like. The MTC-GW information requesting unit 114 selects an MTC gateway device with the best communication quality represented by the calculated index value.

(2) Select an MTC gateway device that can afford the largest registrable number of terminals.

Information indicating the maximum number of registrable MTC terminal devices (maximum registrable number information), and information indicating the number of currently-registered MTC terminal devices (currently-registered number information) are previously included in the MTC gateway information.

The MTC-GW information requesting unit 114 retrieves the maximum registrable number information and the registered number information from the MTC gateway information, and divides the maximum number indicated by the retrieved maximum registrable number information by a number indicated by the currently-registered number information, thus calculating serving capacity. The MTC-GW information requesting unit 114 selects an MTC gateway device with the largest serving capacity.

In the MTC gateway device 13, however, when an MTC terminal registration request signal is received, the MTC terminal registering unit 1391 counts the number of currently-registered MTC terminal devices to generate currently-registered number information. The MTC terminal registering unit 1391 transmits to the SGSN/MME 115, the generated currently-registered number information and the previously-stored maximum registrable number information.

The MTC-GW registering unit 156 of the SGSN/MME 115 receives from the MTC gateway device 13, the currently-registered number information and the maximum registrable number information. The MTC-GW registering unit 156 reads from the MTC-GW information storing unit 154, MTC gateway information concerning the MTC gateway device having received the currently-registered number information and the maximum registrable number information, and updates the read MTC gateway information by including therein the currently-registered number information and the maximum registrable number information. The MTC-GW registering unit 156 stores the updated MTC gateway information in the MTC-GW information storing unit 154.

(3) Select an MTC gateway device 13 for which the MTC terminal device 11 is compatible with radio access technology (RAT, radio access technology) to be used to establish connection.

Access technical information indicating RAT to be used by the MTC gateway device 13 is previously included in the MTC gateway information. Examples of the RAT include a scheme defined by IEEE 802.15.1, IEEE 802.15.4, and the like.

The MTC-GW information requesting unit 114 of the MTC terminal device 11 retrieves the access technical information from the MTC gateway information, and selects as a candidate, an MTC gateway device 13 for which the retrieved access technical information matches the previously-stored access technology information of the MTC terminal device 11. The MTC-GW information requesting unit 114 excludes from the selection targets, an MTC gateway device 13 for which the retrieved access technical information does not match the previously-stored access technology information of the MTC terminal device 11.

(4) Select an MTC gateway device 13 that performs communication with a service attribute matching that of the service to be provided.

Service attribute information representing a service attribute concerning communication to be performed by the MTC gateway device 13 is previously included in the MTC gateway information. Examples of the service attribute include power information, security, medical and health, and the like.

The MTC-GW information requesting unit 114 of the MTC terminal device 11 retrieves the service attribute information from the MTC gateway information, and select as a candidate, an MTC gateway device 13 for which the retrieved service attribute information matches the previously-stored service attribute information of the MTC terminal device 11. The MTC-GW information requesting unit 114 excludes from the selection targets, an MTC gateway device 13 for which the retrieved service attribute information does not match the previously-stored service attribute information of the MTC terminal device 11.

Although the description has been given above taking as an example a case where data generated by the MTC terminal device 11 and the short-range wireless terminal device 12 is transmitted to the MTC server device 17, the present embodiment is not limited thereto. The present embodiment is applicable even to a combination of a case where at least one of the MTC terminal device 11 and the short-range wireless terminal device 12 receives data from the MTC server device 17, and a case where the at least one device transmits data to the MTC server device 17.

Although the description has been given above taking as an example a case where the MTC terminal device 11 transmits an MTC terminal registration request signal to the MTC gateway device 13 indicated by the MTC gateway information received from the SGSN/MME 15, the present embodiment is not limited thereto. In the present embodiment, the MTC terminal registration request signal may be transmitted to the MTC gateway device 13.

The description has been given above taking as an example a case where an MTC-GW operation request signal is transmitted to the SGSN/MME 15 if the MTC terminal registration response signal received by the MTC terminal device 11 from the MTC gateway device 13 indicates “inoperable”, or if an MTC terminal registration response signal is not received. However, the present embodiment is not limited thereto, and the MTC terminal device 11 may first transmit an MTC-GW operation request signal to the SGSN/MME 15. In this case, the MTC terminal device 11 may transmit an MTC gateway information request signal after a predetermined time elapses from the time the MTC-GW operation response signal indicating “inoperable” is received from the SGSN/MME 15 or the time an MTC-GW operation request signal is transmitted.

As described above, the present embodiment relates to a communication system including a gateway device that connects a public wireless communication network and a short-range wireless communication network, a terminal device, a base station device, and a mobile management device that stores base station device information that identifies the base station device and gateway information concerning the gateway device while associating those information with each other. The terminal device transmits to the mobile management device, a gateway information request signal that requests gateway information concerning the gateway device. When the terminal device cannot be connected to the gateway device associated with the gateway information, the terminal device transmits to the mobile device management device, an operation request signal that requests operation while regarding the terminal device as a gateway device. The mobile management device receives from the terminal device via the base station device, a gateway request signal that requests the gateway information, and transmits to the terminal device, gateway information concerning the base station device having relayed the gateway request signal. When an operation request signal is received from the terminal device via the base station device, the mobile management device stores the gateway information concerning the terminal device in association with the base station device information.

Therefore, in the present embodiment, if the terminal device cannot be connected to the short-range wireless communication network that is under the control of the gateway device, the terminal device operates as a gateway device. Thus, it is possible to ensure opportunities for the terminal device itself to transmit and receive data and easily configure a short-range wireless network that connects another terminal device.

A computer may implement part of the MTC terminal device 11, the short-range wireless terminal device 12, the MTC gateway device 13, or the SGSN/MME 15 of the above-described embodiment, for example, the base station device searching units 113 and 133, the MTC-GW information requesting unit 114, the registration requesting unit 115, the MTC data processing units 116 and 126, the MTC-GW operation requesting units 118 and 138, the MTC-GW processing unit 119 and 139, the MTC-GW information providing unit 155, the MTC-GW registering unit 156, the terminal registering unit 157, and the channel setting unit 159. In this case, a program for implementing those control functions may be recorded on a computer-readable recording medium, so that a computer system can read and execute the program recorded on the recording medium to implement the control functions. Here, the “computer system” means the computer systems included in the MTC terminal device 11, the short-range wireless terminal device 12, the MTC gateway device 13, or the SGSN/MME 15, and may include an OS and hardware such as peripheral devices. Additionally, the “computer-readable recording medium” means a storage device, such as: a portable medium, for example, a flexible disk, a magneto optical disk, a ROM, or a CD-ROM; or a hard disk built in a computer system. Further, the “computer-readable recording medium” may also include a medium that dynamically stores a program for a short period, such as a communication line in a case where the program is transmitted via a network such as the Internet, or a communication line such as a telephone line. Moreover, the “computer-readable recording medium” may also include a medium that temporarily stores a program, such as a volatile memory included in a computer system which serves as a server or client in the above case. Additionally, the above program may be a program for implementing part of the above-described functions. Further, the above program may be a program that can implement the above-described functions in combination with the program already stored in the computer system.

Additionally, part or whole of the MTC terminal device 11, the short-range wireless terminal device 12, the MTC gateway device 13, or the SGSN/MME 15 of the above-described embodiment may be implemented as an integrated circuit, such as an LSI (large scale integration). Each functional block of the MTC terminal device 11, the short-range wireless terminal device 12, the MTC gateway device 13, and the SGSN/MME 15 may be individually made into a chip. Alternatively, part or whole of the functional blocks may be integrated and made into a chip. Additionally, the method of forming an integrated circuit is not limited to LSI, and an integrated circuit may be implemented by a dedicated circuit or a general-purpose processor. Further, if technology of forming an integrated circuit, which replaces LSI, arises as a result of advances in semiconductor technology, an integrated circuit formed by that technology may be used.

Although one embodiment of the present invention has been described in detail with reference to the drawings, the specific configuration is not limited to the above, and various design modifications and the like can be made without departing from the scope of the present invention.

### INDUSTRIAL APPLICABILITY

The present invention is applicable to a terminal device, a mobile management device, a communication system, a communication method, and the like, for which a short-range wireless network for MTC can be easily constructed.

### DESCRIPTION OF REFERENCE NUMERALS

1: communication system
11 (11-1 to 11-3): MTC terminal device
111: public network transceiver unit
1111: public network IF unit
1112: public network processing unit
112: short-range network transceiver unit
1121: short-range network IF unit
1122: short-range network processing unit
113: base station device searching unit
114: MTC-GW information requesting unit
115: registration requesting unit
116: MTC data processing unit
1161: storing unit
1162: data generating unit
1163: data transmission control unit
118: MTC-GW operation requesting unit
119: MTC-GW processing unit
1191: MTC terminal registering unit
1192: MTC terminal information storing unit
1193: data transferring unit
12: short-range wireless terminal device
122: short-range network transceiver unit
1221: short-range network IF unit
1222: short-range network processing unit
126: MTC data processing unit
1261: storing unit
1262: data generating unit
1263: data transmission control unit
13: MTC gateway device
131: public network transceiver unit
1311: public network IF unit
1312: public network processing unit
132: short-range network transceiver unit
1321: short-range network IF unit
1322: short-range network processing unit
133: base station device searching unit
138: MTC-GW operation requesting unit
139: MTC-GW processing unit
1391: MTC terminal registering unit
1392: MTC terminal information storing unit
1393: data transferring unit
14: base station device
15: SGSN/MME
153: backbone network transceiver unit
1531: backbone network IF unit
1532: backbone network processing unit
154: MTC-GW information storing unit
155: MTC-GW information providing unit
156: MTC-GW registering unit
157: terminal registering unit
158: terminal information storing unit
159: channel setting unit
16: GGSN/PGW
17: MTC server device

1. A terminal device comprising:
an operation requesting unit configured to, in a case that the terminal device is unable to be connected to a gateway device configured to connect a public wireless communication network and a short-range wireless communication network, transmit to the mobile management device, a gateway operation request signal that requests operation while regarding the terminal device as a gateway device.

2. The terminal device according to claim 1, further comprising:
a data processing unit configured to, in a case that the terminal device is able to be connected to the gateway device configured to connect the public wireless communication network and the short-range wireless communication network, transmit or receive data concerning a predetermined service, via the gateway device.

3. The terminal device according to claim 1, further comprising:
a data transferring unit configured to transmit to a base station device, data received from another terminal device, or transmit to the other terminal device, data received from the base station device.

4. A mobile management device comprising:
a gateway information storing unit configured to store base station device information and gateway information in association with the base station device information, the base station device identifying a base station device, and the gateway information concerning a gateway device connected to the base station device, the gateway device being configured to connect a public wireless communication network and a short-range wireless communication network;
a gateway information providing unit configured to receive from a terminal device via a base station device, a gateway request signal that requests gateway information, and transmit to the terminal device, gateway information concerning the base station device relaying the gateway request signal; and
a gateway information registering unit configured to, in a case that an operation request signal that requests operation while regarding the terminal device as the gateway device is received from the terminal device via the base station device, have the gateway information storing unit store gateway information concerning the terminal device in association with the base station device information.

5. A communication system comprising:
a gateway device configured to connect a public wireless communication network and a short-range wireless communication network;
a terminal device;
a base station device;
a mobile management device configured to store base station information that identifies the base station device and gateway information concerning the gateway device,
wherein the terminal device comprises:
an operation requesting unit configured to, in a case that the terminal device is unable to be connected to the gateway device, transmit to the mobile management device, an operation request signal that requests operation while regarding the terminal device as a gateway device.

6. A communication method for a terminal device, the communication method comprising:
a step for the terminal device to, in a case that the terminal device is unable to be connected to the gateway device, transmit to the mobile management device, an operation request signal that requests operation while regarding the terminal device as a gateway device.

7. A communication method for a mobile management device including a gateway information storing unit configured to store base station device information and gateway information in association with the base station device information, the base station device identifying a base station device, and the gateway information concerning a gateway device connected to the base station device, the gateway device being configured to connect a public wireless communication network and a short-range wireless communication network, the communication method comprising:
a first step for the mobile management device to receive from a terminal device via a base station device, a gateway request signal that requests gateway information, and transmit to the terminal device, gateway information concerning the base station device relaying the gateway request signal; and
a second step for the mobile management device to, in a case that an operation request signal that requests operation while regarding the terminal device as the gateway device is received from the terminal device via the base station device, have the gateway information storing unit store gateway information concerning the terminal device in association with the base station device information.
